(19) United States
(12) Patent Application Publication
(10) Pub. No.: US 2009/0187874 A1
(43) Pub. Date: Jul. 23, 2009

(54) CIRCUIT AND CIRCUIT DESIGN METHOD

(75) Inventors: Mao-Lin Wu, Hsinchu County (TW); Shih-Hung Lin, Hsinchu City (TW); Hua Wu, Hsinchu County (TW); Che Yuan Jao, Hsinchu City (TW); Ching-Chih Li, Taipei County (TW); Sheng-Ming Chang, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/015,627

(22) Filed: Jan. 17, 2008

(51) Int. Cl. G06F 17/50

(52) U.S. Cl. 716/15; 716/12

(57) ABSTRACT

A circuit and a circuit design method are provided. The circuit operates between a first power source voltage and a ground voltage. The circuit comprises at least one low speed circuit path and at least one high speed circuit path. The low speed circuit path adjusts voltage level at the first power source voltage or the ground voltage. The low speed circuit path provides a first return path and isolates unwanted noise signals for a signal on the high speed circuit path.

### BACKGROUND OF THE INVENTION

1. Field of the Invention

The invention relates to a circuit, and in particular relates to a circuit board with specific circuit paths operating at power voltage or ground voltage providing more signal return paths.

2. Description of the Related Art

With the continuing development of advanced technology, circuit functions have become more and more. Thus, circuits need more and more pins to transmit/receive signals to/from other circuits or terminals.

A circuit comprises mainly three types of pins. Some pins are signal pins for transmitting or receiving signals, some pins are GPIO (general purpose I/O) pins for a user to program pins for specific functions and some pins are power pins, such as power pins or ground pins. Since functions of circuits are increasing, corresponding pin requirements are also increasing. However, with regard to a fixed circuit package size, the circuit has a fixed number of pins. In some situations for design engineering considerations, such as requirements for more signal pins or less total number of pins for a circuit package, ground pins of a circuit will be not enough for signal return paths. If the circuit does not have enough signal return paths, the resistance of the signal return path increases and some unwanted noise signals and EM (Electric-Magnetic) problems occur accordingly.

### BRIEF SUMMARY OF THE INVENTION

A detailed description is given in the following embodiments with reference to the accompanying drawings.

An embodiment of a circuit is provided. The circuit operates between a first power source voltage and a ground voltage. The circuit comprises at least one low speed circuit path and at least one high speed circuit path. The low speed circuit path adjusts voltage level at the first power source voltage or the ground voltage. The low speed circuit path provides a first return path and isolates unwanted noise signals for a signal on the high speed circuit path.

Another embodiment of a circuit design method is provided. A circuit operates between a first power source voltage and a ground voltage and comprises at least one low speed circuit path and at least one high speed circuit path. The method comprises adjusting the low speed circuit path at the first power source voltage or the ground voltage and adjusting the high speed circuit path between the first power source voltage and the ground voltage. The low speed circuit path provides a first return path and isolates unwanted noise signals for a signal on the high speed circuit path.

### BRIEF DESCRIPTION OF THE DRAWINGS

The invention can be more fully understood by reading the subsequent detailed description and examples with references made to the accompanying drawings, wherein:

FIG. 1 is a schematic diagram of an interconnection between a circuit and corresponding terminals according to an embodiment of the invention;

FIG. 2 is a schematic diagram of a printed circuit board connecting a flexible printed circuit with low speed circuit paths, high speed circuit paths and quasi-state circuit paths according to another embodiment of the invention;

FIG. 3 is a CMOS inverter for low speed circuit paths and quasi-state circuit paths adjusting voltage levels at the power source voltage or the ground voltage according to another embodiment of the invention;

FIG. 4 is an E-field plot of a flexible printed circuit according to another embodiment of the invention; and

FIG. 5 is a signal plot diagram according to the above embodiment of FIG. 4.

FIG. 6 is an E-field plot of a flexible printed circuit according to another embodiment of the invention; and

FIG. 7 is a signal plot diagram according to the above embodiment of FIG. 6.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

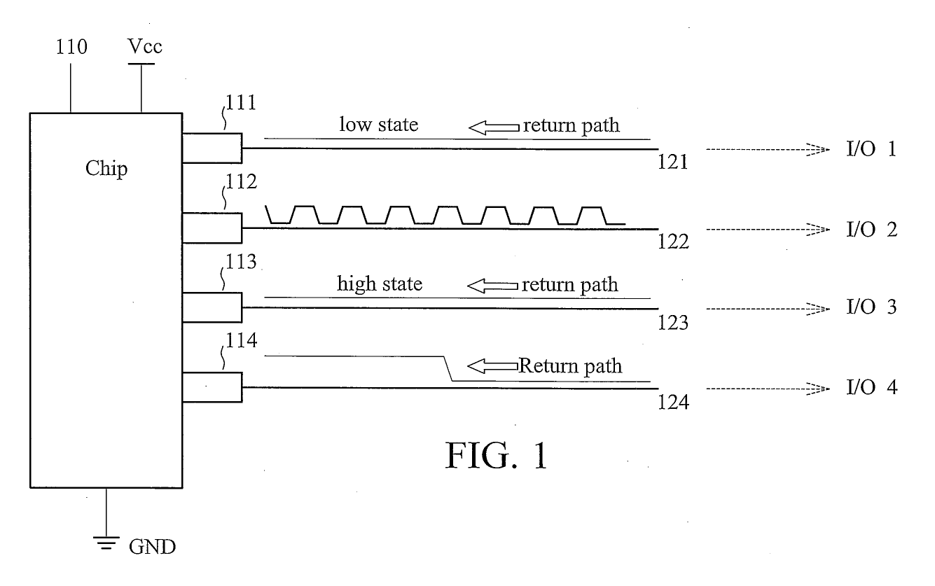

FIG. 1 is a schematic diagram of an interconnection between a chip 110 and corresponding terminals according to an embodiment of the invention. The chip 110 operates between a power source voltage VCC and a ground voltage and comprises pins 111, 112, 113, 114 and so on . . . for transmitting or receiving signals. Pin 111 receives or transmits signals through low speed circuit path 121 to terminal I/O 1. As shown in FIG. 1, the signals on low speed circuit path 121 are at low voltage level (low state) and do not often adjust voltage levels. It is noted that the low voltage level is the ground voltage level. If the signal on low speed circuit path 121 adjusts to the high voltage level (high state), the high voltage level is the power source voltage VCC. Pin 112 receives or transmits signals through high speed circuit path 122 to terminal I/O 2. As shown in FIG. 1, the signals on high speed circuit path 122 are high speed signals that adjust voltage levels at a high frequency.

Pin 113 receives or transmits signals through low speed circuit path 123 to terminal I/O 3. As shown in FIG. 1, the signals on low speed circuit path 123 are at high voltage level (high state) and do not often adjust voltage levels. It is noted that the high voltage level is the power source voltage VCC. If the signal on low speed circuit path 123 adjusts to the low voltage level (low state), the low voltage level is the ground voltage GND. Pin 114 receives or transmits signals through quasi-state circuit path 124 to terminal I/O 4. As shown in FIG. 1, the signals on quasi-state circuit path adjust voltage level at a high voltage level (high state) or a low voltage level (low state) at a very low frequency. The high voltage level is the power source voltage VCC and the low voltage level is the ground voltage GND. Since the low speed circuit path 121 is at the ground voltage GND or power source Voltage VCC, the low speed circuit path 121 can provide a return path for the high speed circuit path 122 and isolate unwanted noise signals (shielding effect function). The low speed circuit path 123 has the same function as the low speed circuit path 121. With regard to the quasi-state circuit path 124, since the quasi-state circuit path 124 adjusts voltage level at power voltage VCC or ground voltage GND at very low frequency, the quasi-state circuit path 124 can also provide a return path for the high speed circuit path 122 and isolate unwanted noise signals (shielding effect function).

It is not limited that the chip only comprises two low speed circuit paths, one quasi-state circuit path and one high speed circuit path. Chip 110 can comprises more than two low speed circuit paths, one quasi-state circuit path and one high speed circuit path. In addition, it is preferred that the high speed circuit paths are disposed beside or close to the low speed circuit paths or quasi-state circuit paths.

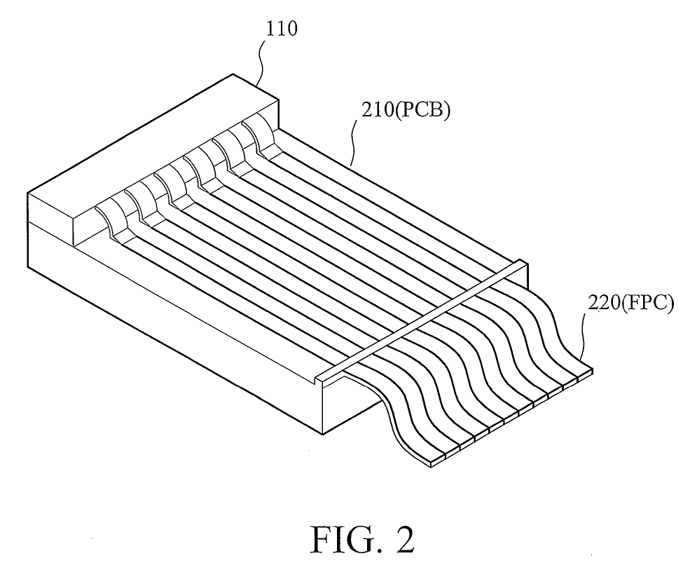

FIG. 2 is a schematic diagram of a printed circuit board 210 connecting a flexible printed circuit 220 with low speed circuit paths, high speed circuit paths and quasi-state circuit paths according to another embodiment of the invention. The low speed circuit paths 121 and 123, high speed circuit path 122 and quasi-state circuit path 124 are connected to circuit 110 through the printed circuit board 210 and to corresponding terminal I/Os through the flexible printed circuit 220. According to an embodiment of the invention, at least one low speed circuit path or quasi-state speed circuit path is disposed beside or close to one high speed circuit path on the printed circuit board 210 and the flexible printed circuit 220 for isolating unwanted noise signals and providing a signal return path that the low speed circuit path or quasi-state speed circuit path adjusts voltage level at the power source voltage VCC or the ground voltage GND. However, it is not limited to use both the printed circuit board 210 and the flexible printed circuit 220. One of the printed circuit board 210 and the flexible printed circuit 220 between chip 110 and corresponding terminal I/Os can be used. In addition, some unused GPIO pins can connect to low speed circuit paths and operate at the power source voltage or the ground voltage for providing a signal return path for the high speed circuit path and preventing unwanted noise signals from affecting the signal on the high speed circuit path.

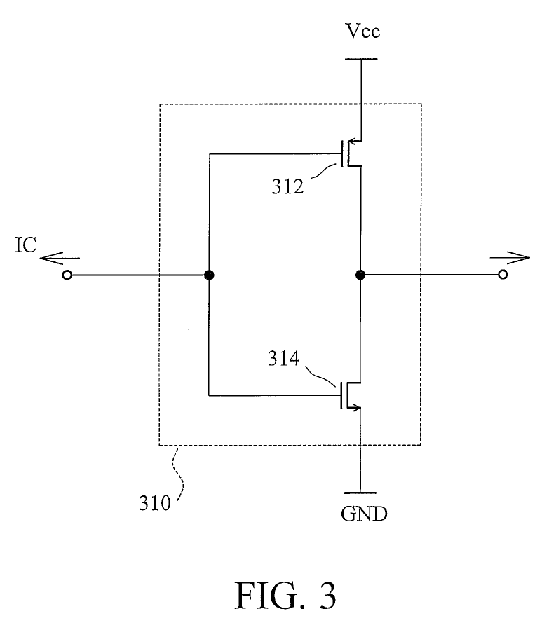

FIG. 3 is a CMOS inverter 310 for low speed circuit paths and quasi-state circuit paths adjusting voltage levels according to another embodiment of the invention. According to an embodiment, low speed circuit paths 121 and 123 and quasi-state circuit path 124 respectively pass through one CMOS inverter 310 to connect to inside circuits of the chip 110. The CMOS inverter 310 comprises PMOS transistor 312 and NMOS transistor 314. The source, gate and drain of the PMOS transistor 312 are respectively coupled to power source voltage VCC, inside circuits of the chip 110 and low speed circuit paths or quasi-state circuit paths. The source, gate and drain of the NMOS transistor 314 are respectively coupled to the ground voltage GND, inside circuits of the chip 110 and low speed circuit paths or quasi-state circuit paths.

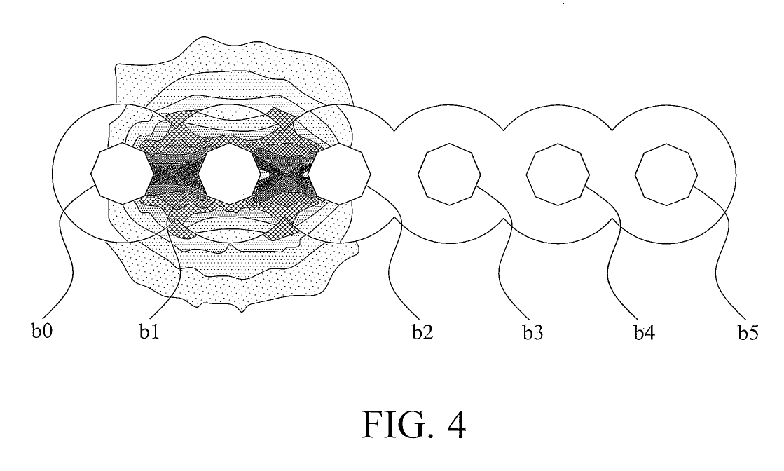

FIG. 4 is an electric field (E-field) plot of a flexible printed circuit according to another embodiment of the invention. There are six circuit paths in the flexible printed circuit. Circuit path b0 is at ground voltage level GND. Other circuit paths b1, b2, b3, b4 and b5 transmit signals which adjust voltage levels between 1.2V to 0V. FIG. 4 only shows the E-field plot between the circuit path b1 and circuit paths b0 and b2.

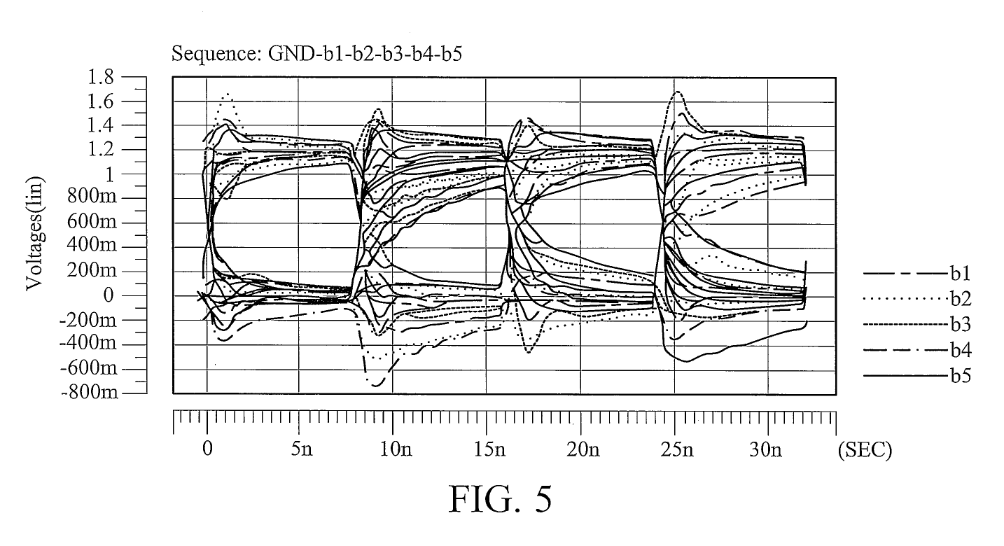

FIG. 5 is a signal eye diagram according to the above embodiment of FIG. 4. The circuit path b0 is at ground voltage level GND. Other circuit paths b1, b2, b3, b4 and b5 transmit signals which adjust voltage levels between 1.2V to 0V. As shown in FIG. 5, the signal degradation of circuit path b5 is the worst because circuit path b5 is the farthest circuit path to the circuit path b0 (GND).

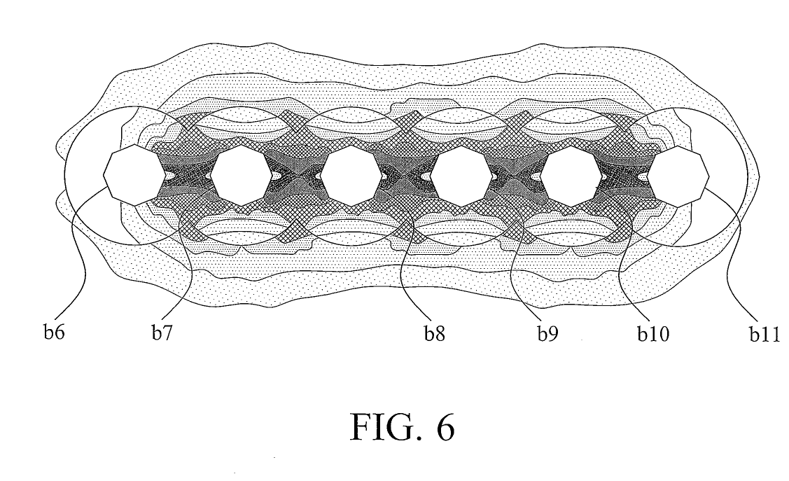

FIG. 6 is an electric field (E-field) plot of a flexible printed circuit according to another embodiment of the invention. There are six circuit paths in the flexible printed circuit. Circuit paths b6, b8 and b10 are at ground voltage level GND. Other circuit paths b7, b9 and b11 transmit signals which adjust voltage levels between 1.2V to 0V.

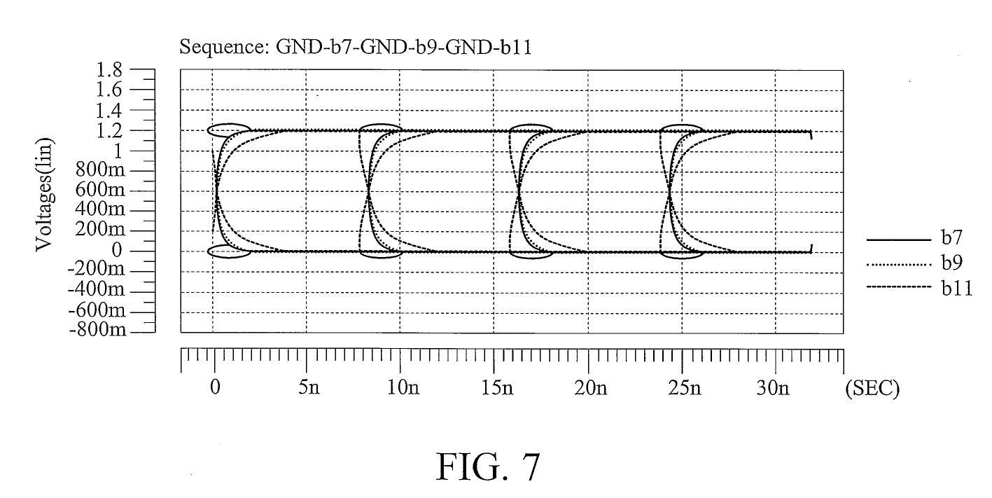

FIG. 7 is a signal eye diagram according to the above embodiment of FIG. 6. The circuit paths b6, b8 and b10 are at ground voltage level GND. Other circuit paths b7, b9 and b11 transmit signals which adjust voltage levels between 1.2V to 0V. As shown in FIG. 7, the signal of circuit path b11 is worse than signals of circuit paths b7 and b9 because circuit path b11 has only one ground side compared to circuit paths b7 and b9 having two ground sides. Comparing FIGS. 4 and 5 to FIGS. 6 and 7, it is therefore obvious that signal quality is improved with more ground circuit paths. According to the above embodiments, using low speed circuit paths and quasi-state circuit paths as ground circuit paths beside the high speed circuit path can improve the signal quality of the high speed circuit path.

While the invention has been described by way of example and in terms of preferred embodiment, it is to be understood that the invention is not limited to thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A circuit operating between a first power source voltage and a ground voltage, comprising
at least one high speed circuit path for transmitting a high speed signal; and
at least one low speed circuit path adjusting voltage level at the first power source voltage or the ground voltage,
wherein the low speed circuit path provides a first return path and isolates unwanted noise signals for the high speed signal on the high speed circuit path.

2. The circuit as claimed in claim 1, wherein the low speed circuit path is coupled to a first CMOS inverter and the first CMOS inverter comprises a first PMOS transistor coupled to the first power voltage and a first NMOS transistor coupled to the ground voltage.

3. The circuit as claimed in claim 1, wherein the low speed circuit path is on a printed circuit board, a flexible printed circuit or both for transmitting a signal from the chip to a corresponding terminal I/O.

4. The circuit as claimed in claim 1, wherein the at least one low speed circuit path is disposed beside the high speed circuit path for providing the first return path.

5. The circuit as claimed in claim 1, further comprising at least one quasi-state circuit path adjusting voltage level at the first power source voltage or the ground voltage for providing a second return path and isolating unwanted noise signals for the high speed signal on the high speed circuit path.

6. The circuit as claimed in claim 5, wherein the circuit comprises a chip with a first pin connected to the low speed circuit path, a second pin connected to the quasi-state circuit path and a third pin connected to the high speed circuit path.

7. The circuit as claimed in claim 6, wherein the first pin and the second pin of the chip are unused GPIO pins.

8. The circuit as claimed in claim 5, wherein the quasi-state circuit path is coupled to a second CMOS inverter and the second CMOS inverter comprises a second PMOS transistor coupled to the first power voltage and a second NMOS transistor coupled to the ground voltage.

9. The circuit as claimed in claim 5, wherein the quasi-state circuit path is on a printed circuit board, a flexible printed circuit or both for transmitting a signal from the chip to a corresponding terminal I/O.

10. The circuit as claimed in claim 5, wherein the at least one quasi-state circuit path is disposed beside the high speed circuit path for providing the second return path.

11. A circuit design method, wherein a circuit operates between a first power source voltage and a ground voltage and comprises at least one low speed circuit path and at least one high speed circuit path, comprising
adjusting a voltage level on the low speed circuit path at the first power source voltage or the ground voltage; and
adjusting a voltage level of a signal on the high speed circuit path between the first power source voltage and the ground voltage,
wherein the low speed circuit path provides a first return path and isolates unwanted noise signals for the signal on the high speed circuit path.

12. The circuit design method as claimed in claim 11, wherein the low speed circuit path is coupled to a first CMOS inverter and the first CMOS inverter comprises a first PMOS transistor coupled to the first power voltage and a first NMOS transistor coupled to the ground voltage.

13. The circuit design method as claimed in claim 11, wherein the low speed circuit path is on a printed circuit board, a flexible printed circuit or both for transmitting a signal from the chip to a corresponding terminal I/O.

14. The circuit design method as claimed in claim 11, wherein the at least one low speed circuit path is disposed beside the high speed circuit path for providing the first return path.

15. The circuit design method as claimed in claim 11, wherein the circuit comprises at least one quasi-state circuit path and the quasi-state circuit path adjusts voltage level at the first power source voltage or the ground voltage for providing a second return path and isolating unwanted noise signals for the signal on the high speed circuit path.

16. The circuit design method as claimed in claim 15, wherein the circuit comprises a chip with a first pin connected to the low speed circuit path, a second pin connected to the quasi-state circuit path and a third pin connected to the high speed circuit path.

17. The circuit design method as claimed in claim 16, wherein the first pin and the second pin of the chip are unused GPIO pins.

18. The circuit design method as claimed in claim 15, wherein the quasi-state circuit path is coupled to a second CMOS inverter and the second CMOS inverter comprises a second PMOS transistor coupled to the first power voltage and a second NMOS transistor coupled to the ground voltage.

19. The circuit design method as claimed in claim 15, wherein the quasi-state circuit path is on a printed circuit board, a flexible printed circuit or both for transmitting a signal from the chip to a corresponding terminal I/O.

20. The circuit design method as claimed in claim 15, wherein the at least one quasi-state circuit path is disposed beside the high speed circuit path for providing the second return path.
